(19) United States
(12) Patent Application Publication
(10) Pub. No.: US 2013/0036028 A1
(43) Pub. Date: Feb. 7, 2013

(54) MARKETPLACE LISTING SYSTEMS AND METHODS

(71) Applicants: Mohan Patt, Hayward, CA (US); Nishant Asthana, San Jose, CA (US); Famous Rhodes, San Jose, CA (US); Ryan M. Tominaga, Salt Lake City, UT (US); Dan Tsuchiya, Los Gatos, CA (US)

(72) Inventors: Mohan Patt, Hayward, CA (US); Nishant Asthana, San Jose, CA (US); Famous Rhodes, San Jose, CA (US); Ryan M. Tominaga, Salt Lake City, UT (US); Dan Tsuchiya, Los Gatos, CA (US)

(73) Assignee: eBay Inc., San Jose, CA (US)

(21) Appl. No.: 13/198,407

(22) Filed: Aug. 4, 2011

(51) Int. Cl. G06Q 30/00

(52) U.S. Cl. 705/27.1

(57) ABSTRACT

A method and system generate and manage marketplace listings. In some embodiments, the method receives product information from a catalog service. The method also receives a product listing request from the catalog service that identifies a product contained in the product information. The product listing request is generated by a distributor associated with the catalog service. The method accesses distributor data associated with the distributor initiating the product listing request and accesses a listing template associated with the product information. A marketplace listing is generated based on the product, the distributor data, and the listing template.

### RELATED APPLICATION

This application is related to concurrently filed U.S. patent application Ser. No. ______, filed on Aug. ______, 2011, entitled “SYSTEMS AND METHODS FOR GENERATING MARKETPLACE LISTINGS”, and identified by Docket No. 2043.942US1.

### TECHNICAL FIELD

The present disclosure generally relates to data processing techniques and, more specifically, to systems and methods for handling marketplace listings.

### BACKGROUND

Advancements in computer and networking technology enable users and entities to conduct various types of transactions online via computer-based applications and systems. These advancements have caused the growth of electronic commerce, commonly referred to as “ecommerce”, and the development of network-based marketplaces that allow multiple users and entities to shop and execute various online transactions.

Some distributors of products and services use existing distribution channels that offer items through a catalog or similar listing of items. These existing catalogs may not allow a distributor to easily offer products or services through a network-based marketplace. In these situations, the distributor may manually list products or services with the network-based marketplace, which can be time-consuming and may involve additional personnel costs.

### BRIEF DESCRIPTION OF THE DRAWINGS

Some embodiments are illustrated by way of example and not limitation in the figures of the accompanying drawings.

FIG. 1 is a block diagram depicting an example environment capable of implementing the systems and methods discussed herein.

FIG. 2 is a block diagram of a marketplace listing system, in accordance with some embodiments of the present invention.

FIG. 3 is a flow diagram of a method, in accordance with an embodiment, for listing items with a network-based marketplace.

FIG. 4 is a flow diagram of a method, in accordance with an embodiment, for generating marketplace listings.

FIG. 5 is a flow diagram of a method, in accordance with an embodiment, for communicating sale and shipping information associated with items listed with a network-based marketplace.

FIG. 6 depicts, in accordance with an embodiment, example data associated with a listing template.

FIGS. 7A-7D depict, in accordance with an embodiment, various portions of an example marketplace listing.

FIG. 8 is a network diagram depicting a client-server system within which an example embodiment may be deployed.

FIG. 9 is a block diagram of a machine in the example form of a computer system within which a set of instructions, for causing the machine to perform any one or more of the methodologies discussed herein, may be executed.

### DETAILED DESCRIPTION

Example systems and methods to generate and manage marketplace listings are described. In the following description, for purposes of explanation, numerous specific details are set forth in order to provide a thorough understanding of example embodiments. It will be evident, however, to one skilled in the art that the present invention may be practiced without these specific details.

The marketplace listing systems and methods described herein allow distributors (e.g., sellers) to list multiple items with a network-based marketplace without requiring the distributors to have detailed knowledge of the item listing procedures associated with the network-based marketplace. A catalog service provides product information used with a listing template to generate one or more marketplace listings. Additionally, distributor data is applied to the listing template based on the particular distributor requesting the marketplace listing. The described systems and methods further manage network-based marketplace listings based on distributor inventory data and other factors.

As used herein, a “distributor”, a “user” or an “entity” may be a person (e.g., a human), a business (e.g., a company), an organization, a group of people, a persona (e.g., a fictitious character), or any combination thereof. Although particular examples discussed herein refer to “products” listed with a network-based marketplace, the teachings of the present invention are applicable to any type of marketplace listing for any product, service, item, and the like.

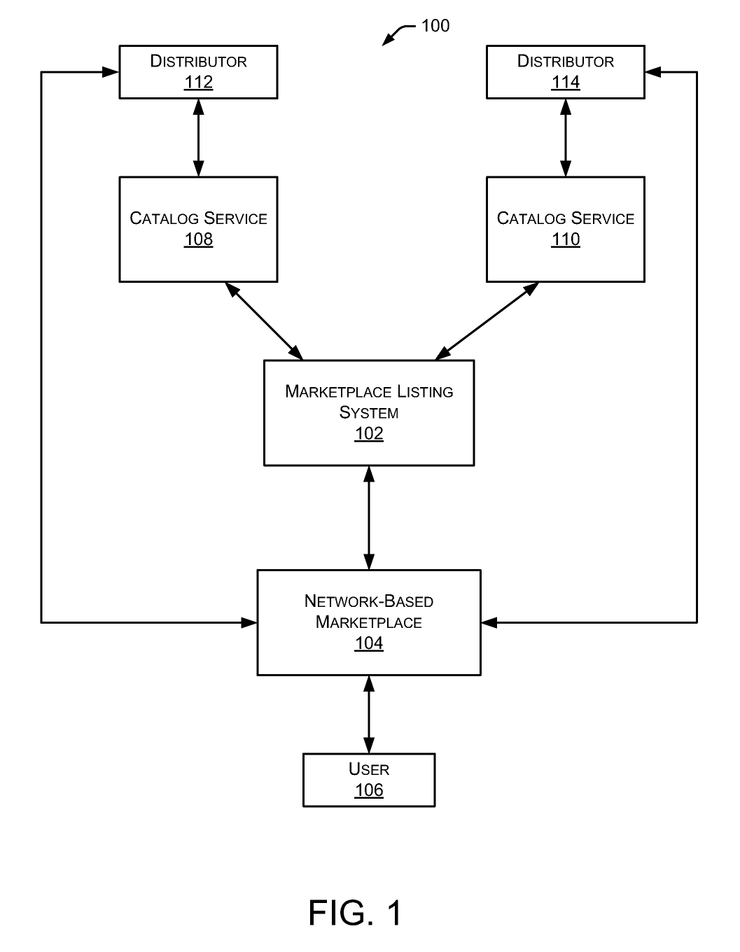

FIG. 1 is a block diagram depicting an example environment 100 capable of implementing the systems and methods discussed herein. A marketplace listing system 102 interacts with various other systems and devices (as described herein) to initiate and manage distributor product listings (also referred to as “marketplace listings”) on a network-based marketplace 104. Network-based marketplace 104 provides an electronic commerce marketplace for users to shop and perform various network-based transactions. Any number of users 106 can access network-based marketplace 104 through one or more data communication networks, such as the Internet. Similarly, marketplace listing system 102 is coupled to network-based marketplace 104 through one or more data communication networks.

Marketplace listing system 102 is also coupled to catalog services 108 and 110, which provide inventory management systems, product descriptions, and other services to distributors 112 and 114. Catalog services 108 and 110 may provide information and services related to thousands of different products that are physically maintained in warehouses or other facilities by multiple distributors. Each product associated with catalog service 108 or 110 has a unique product identifier or product code, such as a SKU (stock-keeping unit). In a particular embodiment, this unique product identifier is used by distributors, catalog services, manufacturers, and other entities throughout an industry. A catalog service is also referred to as a “catalog vendor”, an “electronic catalog service”, and an “online catalog service”. In particular embodiments, catalog services 108 and 110 are private catalog services that restrict access to particular distributors (e.g., distributors having registered with or subscribed to the catalog service). Although FIG. 1 illustrates two distributors 112 and 114, a particular catalog service may support any number of distributors. Further, a particular distributor may access multiple different catalog services.

Catalog services 108 and 110 allow each distributor associated with the catalog service to obtain product information (e.g., product photos, product descriptions, and product fitment data) related to the products offered by the distributor. Thus, instead of maintaining product information itself, the distributors retrieve product information and utilize other services through the catalog service. In a particular embodiment, catalog services 108 and 110 are private catalog services that restrict access to distributors that have subscribed to the catalog service. In this embodiment, the product information maintained by catalog services 108 and 110 is not publicly available.

In a particular implementation, marketplace listing system 102 communicates with catalog services 108 and 110 through one or more data communication networks, such as the Internet. Additionally, distributors 112 and 114 communicate with catalog services 108 and 110 through one or more data communication networks.

As shown in FIG. 1, distributors 112 and 114 also communicate directly with network-based marketplace 104. This communication is, for example, through one or more data communication networks. In a particular embodiment, distributors 112 and 114 communicate with network-based marketplace 104 to create and manage a user account with network-based marketplace 104. As discussed below, this user account allows distributors 112 and 114 to place listings on the network-based marketplace 104. Distributors 112 and 114 do not manually place listings with network-based marketplace 104. Instead, distributors 112 and 114 can utilize the automated marketplace listing procedures supported by marketplace listing system 102, as described herein.

Although FIG. 1 illustrates marketplace listing system 102 coupled to two catalog services 108 and 110, alternate embodiments may include a marketplace listing system coupled to any number of catalog services that each support any number of distributors. FIG. 1 illustrates marketplace listing system 102 as a separate system. In alternate embodiments, marketplace listing system 102 is incorporated into another system or device, such as network-based marketplace 104, catalog service 108 or catalog service 110.

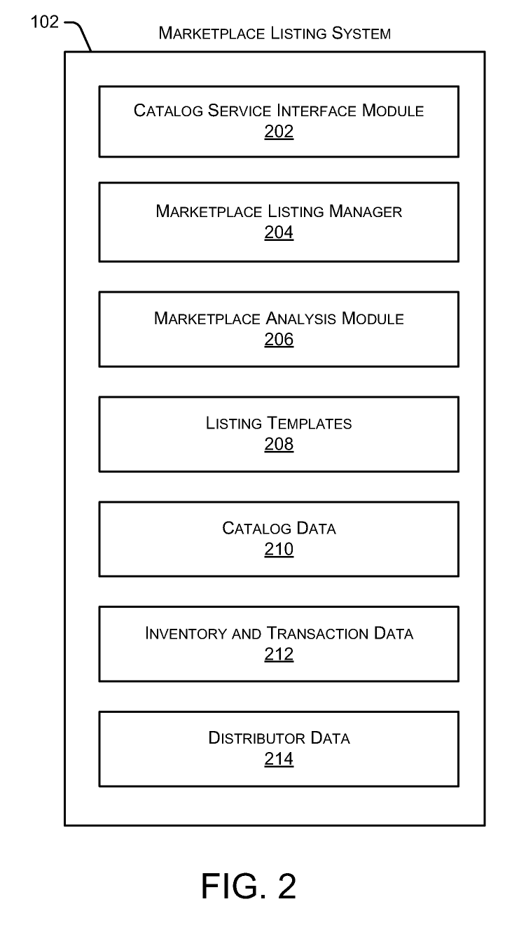

FIG. 2 is a block diagram of marketplace listing system 102, in accordance with some embodiments of the present invention. Marketplace listing system 102 may be executed or included in, for example, a server or other computing device. In various embodiments, marketplace listing system 102 implements computer programs, logic, applications, methods, processes, or software to perform the procedures discussed herein.

In the embodiment of FIG. 2, marketplace listing system 102 includes a catalog service interface module 202, a marketplace listing manager 204, and a marketplace analysis module 206. Catalog service interface module 202 is configured to communicate with one or more catalog services. For example, catalog service interface module 202 may receive data (e.g., product data) from the catalog services and send data (e.g., product sales related to marketplace listings) to the catalog services. Marketplace listing manager 204 is configured to communicate with one or more network-based marketplaces to, for example, initiate new listings, modify existing listings, and receive information regarding sales related to listings. Marketplace listing manager 204 also creates marketplace listings using one or more templates, as discussed below, in combination with various data used to complete the template. Marketplace analysis module 206 is configured to perform various types of analysis and evaluation of marketplace listings (e.g., current marketplace listings and completed marketplace listings). Marketplace analysis module 206 is further configured to generate recommendations regarding marketplace listings, such a pricing recommendations for a particular listing.

Marketplace listing system 102 also includes one or more listing templates 208, catalog data 210, inventory and transaction data 212, and distributor data 214. Listing templates 208 are standardized templates used to generate marketplace listings. The use of listing templates 208 provides a common listing format for all products associated with a particular catalog service, regardless of the distributor initiating the listing. Catalog data 210 includes, for example, product descriptions, product fitment data, product photos, and the like received from a catalog service or other data source. At least a portion of catalog data 210 is included when generating marketplace listings using listing templates 208. Inventory and transaction data 212 includes, for example, current inventory of a particular product by a specific distributor. Inventory and transaction data 212 also includes product sales data and product shipping information (e.g., shipping carrier and shipping status). Distributor data 214 includes, for example, a distributor's return policy, the distributor's geographic location, and a customer feedback rating associated with the distributor. At least a portion of distributor data 214 is included when generating marketplace listings using listing templates 208.

In particular embodiments, catalog service interface module 202, marketplace listing manager 204, and marketplace analysis module 206 may be in the form of software that is processed by a processor. In another example, catalog service interface module 202, marketplace listing manager 204, and marketplace analysis module 206 may be in the form of firmware that is processed by application specific integrated circuits (ASICs), which may be integrated into a circuit board. Alternatively, catalog service interface module 202, marketplace listing manager 204, and marketplace analysis module 206 may be in the form of one or more logic blocks included in a programmable logic device (e.g., a field programmable gate array (FPGA)). Further, one or more of catalog service interface module 202, marketplace listing manager 204, and marketplace analysis module 206 may be adapted, and/or additional structures used to provide alternative or additional functionalities beyond those specifically discussed herein.

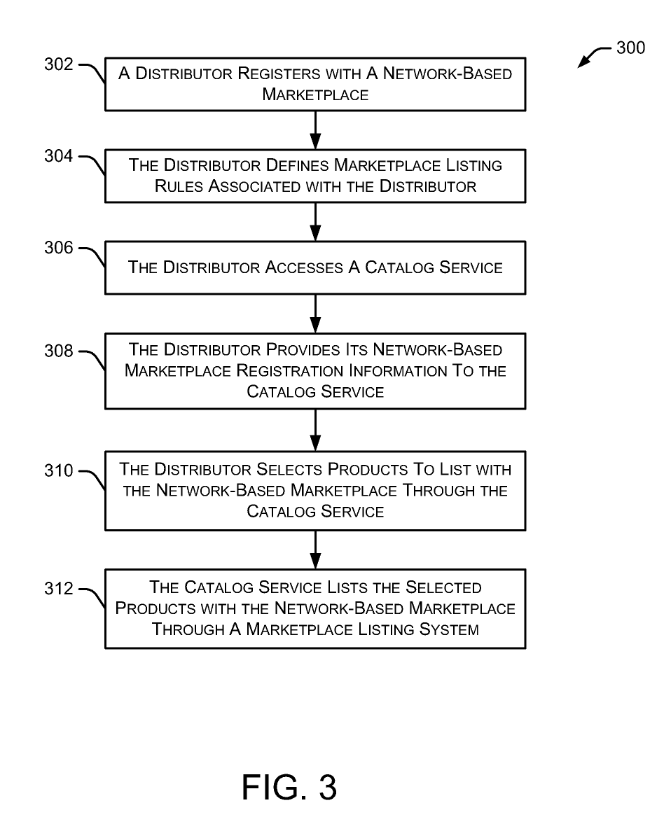

FIG. 3 is a flow diagram of a method 300, in accordance with an embodiment, for listing items with a network-based marketplace. In a particular embodiment, at least a portion of method 300 is implemented by a processor or computing system, such as one or more of the processors and computing systems discussed herein. Initially, a distributor registers with a network-based marketplace at 302. During the registration process, the distributor establishes an account with the network-based marketplace such that the distributor may later place listings in the marketplace. The distributor also defines marketplace listing rules and other information associated with the distributor (or the distributor's business) at 304. These listing rules include, for example, return policies, shipping policies, and the like. Additional information provided by the distributor may include the distributor's geographic location and types of payment accepted.

After registering with the network-based marketplace, the distributor accesses a catalog service at 306. In the example of FIG. 3, the distributor already had a relationship (e.g., membership) with the catalog service. In alternate embodiments, where the distributor does not have a relationship with the catalog service, the distributor subscribes to the catalog service prior to accessing the catalog at 306. After accessing the catalog service, the distributor provides its network-based marketplace registration information to the catalog service at 308. This registration information may include the distributor's user name and password associated with the network-based marketplace. The distributor's registration information is used at a later time to place listings on behalf of the distributor in the network-based marketplace.

To generate marketplace listings, the distributor selects one or more products to list with the network-based marketplace through the catalog service at 310. For example, the catalog service may provide a user interface that allows the distributor to identify specific products and define various parameters associated with the listings, such as price, shipping costs, and the like. The catalog service then lists the selected products with the network-based marketplace through a marketplace listing system at 312. As discussed herein, the marketplace listing system uses listing templates and other data received from the catalog service to generate listings for the products selected by the distributor. Once generated, the marketplace listing system communicates the listings to the network-based marketplace for placement in the marketplace.

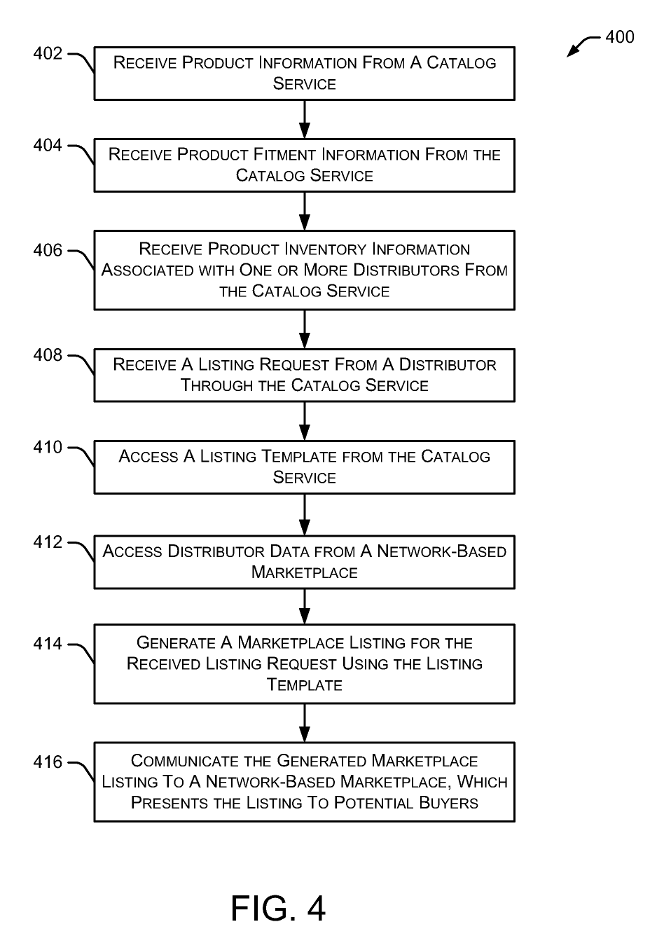

FIG. 4 is a flow diagram of a method 400, in accordance with an embodiment, for generating marketplace listings. In a particular embodiment, at least a portion of method 400 is implemented by a processor or computing system, such as one or more of the processors and computing systems discussed herein. In some embodiments, method 400 is implemented by marketplace listing system 102. Initially, a marketplace listing system receives product information from a catalog service at 402. The product information includes, for example, product descriptions, photographs, part numbers, and the like. Additionally, product fitment information is received from the catalog service at 404. The product fitment information includes systems or devices with which the product is operable. For example, if the product is a part for an automobile, the fitment information for that part may identify the specific car models and model years with which the part is designed to operate.

Method 400 continues as product inventory information associated with one or more distributors is received from the catalog service at 406. The product inventory information identifies an available quantity of the product from one or more distributors that are members of the catalog service. This inventory information may be included in the marketplace listing (e.g., indicating that a particular distributor has five pieces of a particular product available for sale). In particular embodiments, the product information, product fitment information, and product inventory information is stored by the marketplace listing system for generating marketplace listings at a future time. In other embodiments, the product information, product fitment information, and product inventory information is retrieved from the catalog service in response to receiving a listing request from a distributor that requires such information to generate the marketplace listing.

The method continues as the marketplace listing system receives a listing request from a distributor through the catalog service at 408. In response to the listing request, a listing template is accessed (e.g., retrieved) from the catalog service at 410. In an alternate embodiment, the listing template is retrieved from the catalog service during an initialization process (e.g., prior to receiving the listing request from the distributor). In this embodiment, the listing template is stored in the marketplace listing system. In certain implementations, the catalog service uses a common listing template for all items listed in or supported by the catalog service. This common listing template allows customization for a particular distributor by including a distributor name/logo, description of the distributor, and the like. In other implementations, the catalog service uses multiple listing templates and allows each distributor to select a preferred (or default) listing template for the distributor's listings.

After accessing the listing template, distributor data is accessed from a network-based marketplace at 412. The distributor data includes, for example, a return policy, warranty information, distributor logo, and the geographic location of the distributor. In one embodiment, the distributor data is provided by the distributor to the network-based marketplace when the distributor registers (i.e., establishes an account) with the network-based marketplace. In an alternate embodiment, the distributor data is accessed from a catalog service or other data source.

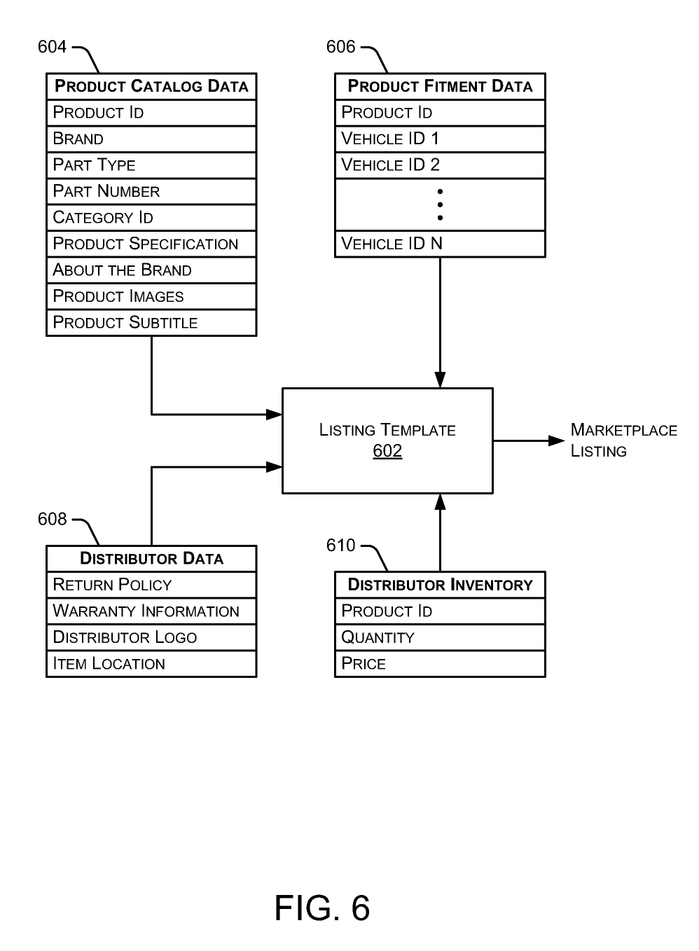

A marketplace listing is then generated using the listing template at 414. As discussed in greater detail below with respect to FIG. 6, the listing template combines product information, product fitment information, product inventory information, and distributor data into a marketplace listing. By using the listing template, a common marketplace listing format is generated for all products associated with a particular catalog service, regardless of the distributor generating the listing request. Finally, the marketplace listing is communicated to a network-based marketplace at 416, which presents the listing to potential buyers (e.g., users of the network-based marketplace).

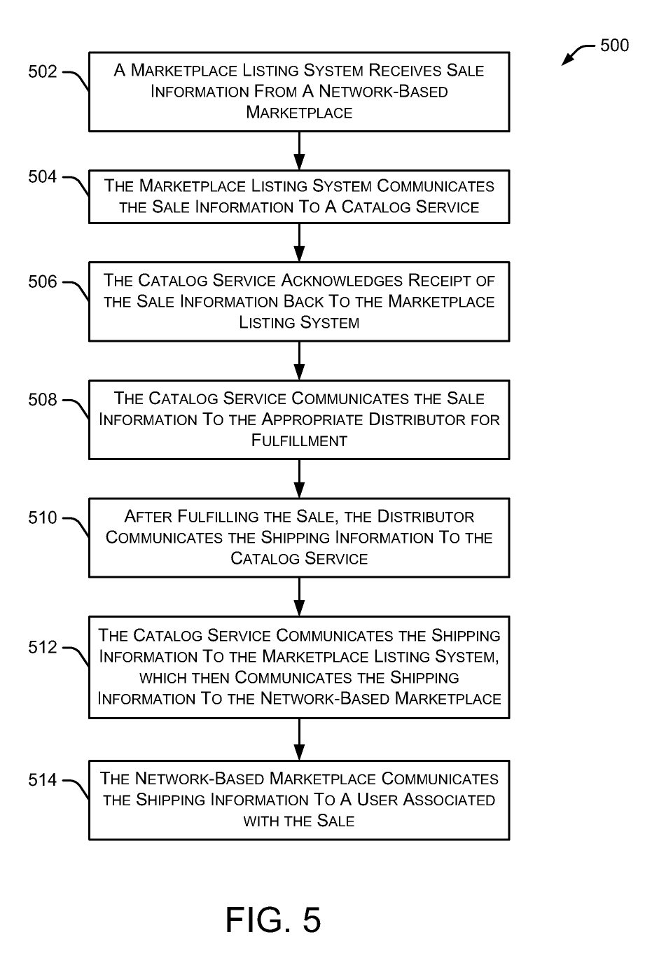

FIG. 5 is a flow diagram of a method 500, in accordance with an embodiment, for communicating sale and shipping information associated with items listed with a network-based marketplace. In a particular embodiment, at least a portion of method 500 is implemented by a processor or computing system, such as one or more of the processors and computing systems discussed herein. Initially, a marketplace listing system receives sale information from a network-based marketplace at 502. For example, marketplace listing system 102 (FIG. 1) receives sale information from network-based marketplace 104 for a marketplace listing generated by the marketplace listing system. The sale information is associated with a particular distributor (i.e., the distributor that generated the original listing request through a catalog service). The sale information may include a listing number (or other identifier uniquely identifying the listing), a sale price, information associated with a user that purchased the product, and the like.

The marketplace listing system communicates the sale information to a catalog service at 504 (e.g., the catalog service that communicated the original listing request to the marketplace listing system). The catalog service acknowledges receipt of the sale information back to the marketplace listing system at 506. Since the marketplace listing system does not communicate directly with the distributor, this acknowledgement is important for confirming to the marketplace listing system that the sale information was received and is being handled by the catalog service. The catalog service communicates the sale information to the appropriate distributor (e.g., the distributor that generated the original listing request) for fulfillment at 508.

After the distributor fulfills the sale (e.g., ships the product to a user associated with the sale), the distributor communicates the shipping information to the catalog service at 510. The shipping information includes, for example, the shipping company, a shipping or tracking number, expected delivery date, and the shipping service level (e.g., ground, expedited service or freight). The catalog service communicates the shipping information to the marketplace listing system, which then communicates the shipping information to the network-based marketplace at 512. Finally, the network-based marketplace communicates the shipping information to a user associated with the sale at 514. The shipping information confirms the completed sale to the various systems and components involved in the listing transaction (i.e., the catalog service, the marketplace listing system, and the network-based marketplace).

FIG. 6 depicts, in accordance with an embodiment, example data associated with a listing template 602. As discussed above, listing template 602 receives various data and generates a marketplace listing based on the received data. Listing template 602 can be used with all products associated with a particular catalog service, or used with specific types (or groups) of products. For example, one listing template is used for automotive parts that have specific fitment data (e.g., brake parts and engine parts) and another listing template is used for automotive parts that do not have associated fitment data (e.g., car wax and engine oil). In a particular embodiment, listing template 602 is used with products from multiple different catalog services.

In the example of FIG. 6, listing template 602 receives product catalog data 604, which includes data about products received from a catalog service or other data source. Each product has associated data including a product ID (e.g., a unique code or other identifier), a brand, a part type, a part number, a category ID, a product specification, information about the brand, product images, and a product subtitle.

Listing template 602 also receives product fitment data 606 from a catalog service or other data source. Product fitment data 606 identifies a product ID (the same product ID contained in product catalog data 604), and multiple vehicles on which the product is appropriate or operable. In the example of FIG. 6, the product is a part for a vehicle. Thus, product fitment data 606 identifies specific vehicles on which the part will operate. In one embodiment, the vehicles are identified by manufacturer, model, and model year. In other embodiments, product fitment data 606 is associated with any type of product usage information.

Listing template 602 additionally receives distributor data 608 from a catalog service, a network-based marketplace, or another data source. Distributor data 608 includes a return policy associated with products purchased from the distributor, warranty information, a logo associated with the distributor's business, and an item location (e.g., a geographic location from which the product is shipped). Listing template 602 further receives distributor inventory data 610 from a catalog service or other data source. Distributor inventory data 610 includes a product ID (the same product ID contained in product catalog data 604 and product fitment data 606), a quantity (e.g., the current quantity available for sale by the distributor), and a price.

The various data received by listing template 602 is arranged as defined by the listing template. The same listing template is used for generating marketplace listings for multiple products from multiple distributors. Thus, a common listing format is produced for all marketplace listings generated using listing template 602. This common listing format provides a uniform buying experience that allows users to more easily identify information associated with a product of interest.

In a particular embodiment, listing template 602 identifies one or more required fields, such as product ID, return information, and price. Data associated with these required fields must be received before the listing template is able to generate a marketplace listing. In this embodiment, certain fields in listing template 602 are flagged as “required” fields, which must be filled to generate a marketplace listing. Other fields in listing template 602 may be “optional” fields (e.g., product images and product subtitle) that are not required to generate a marketplace listing.

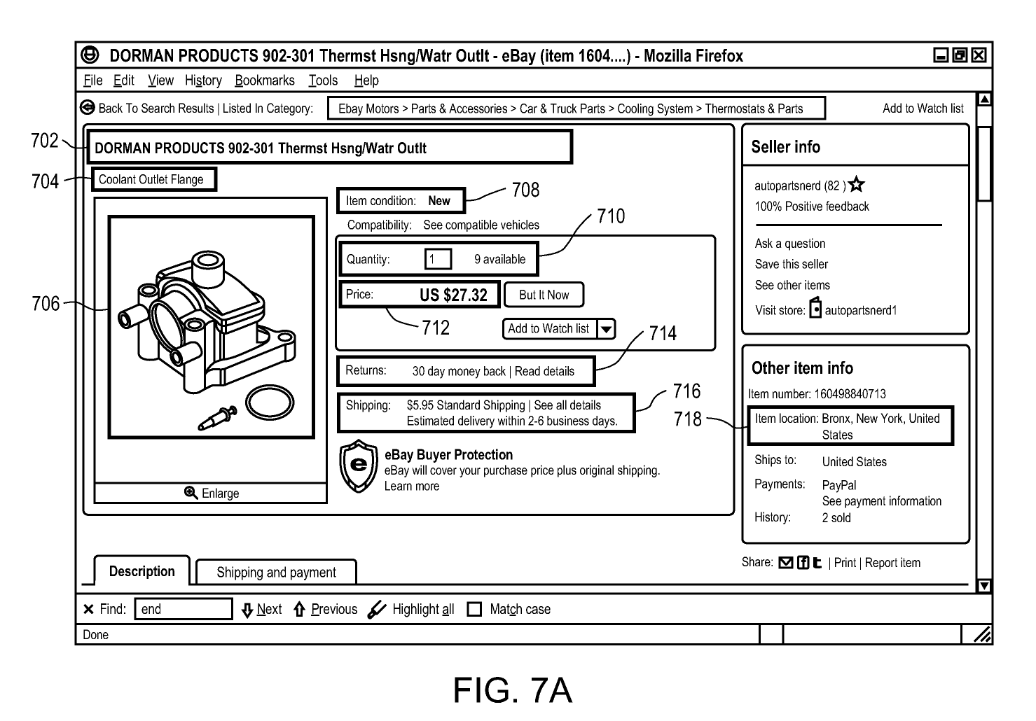

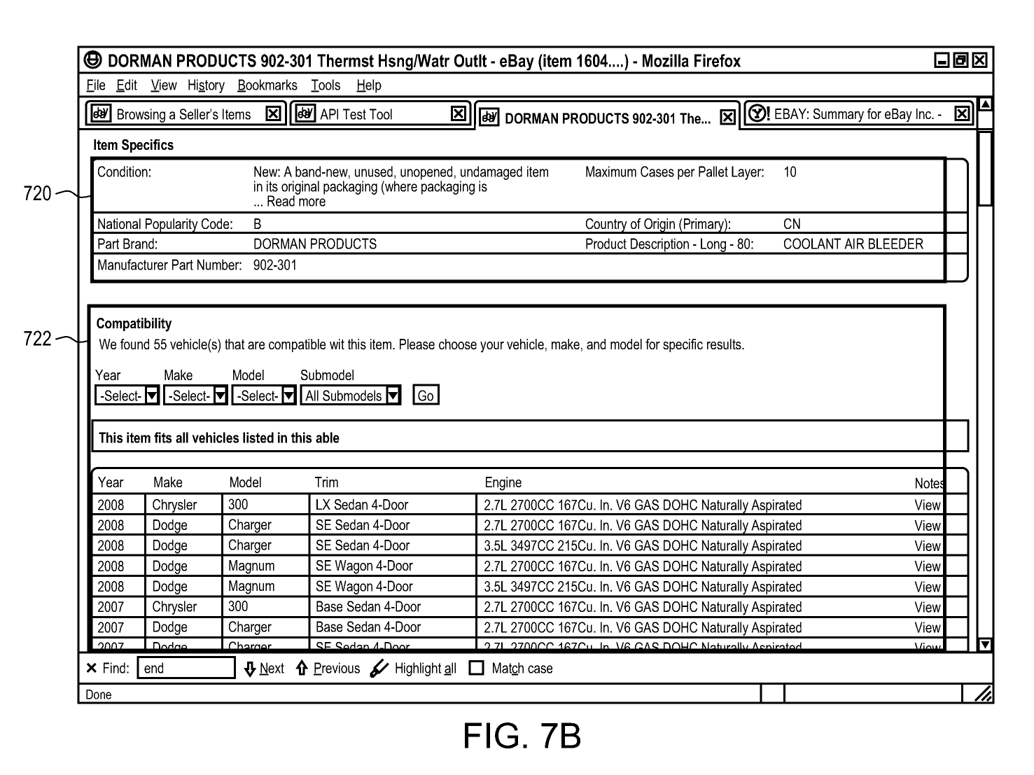

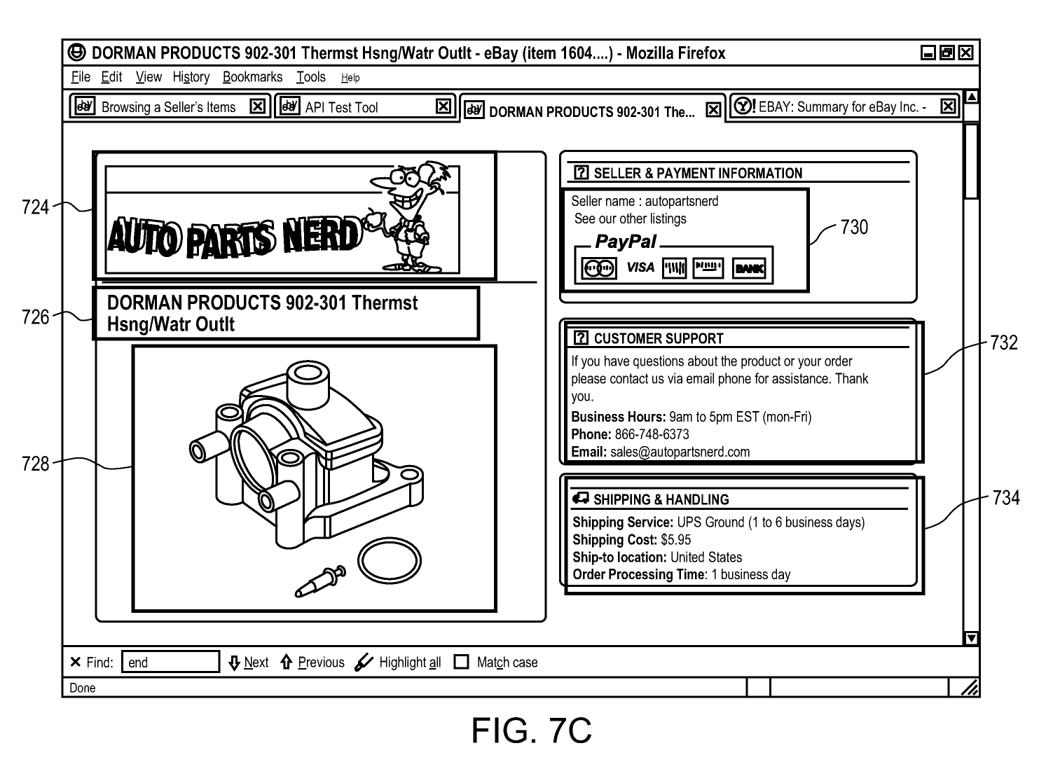

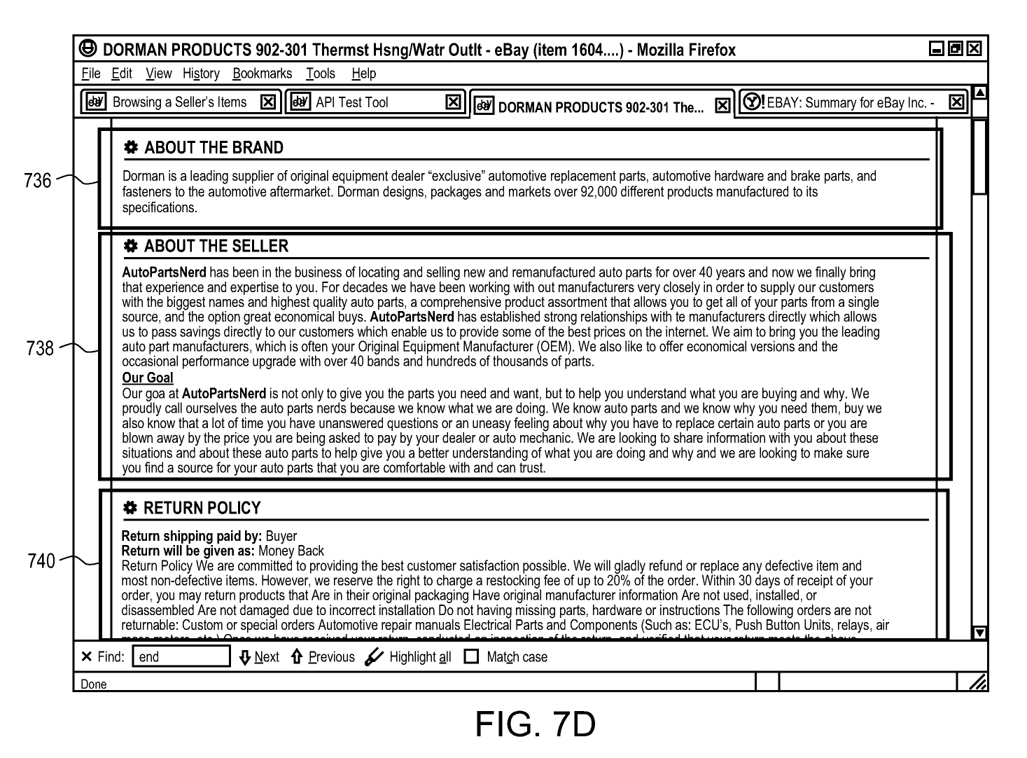

FIGS. 7A-7D depict, in accordance with an embodiment, various portions of an example marketplace listing generated using a listing template of the type discussed above with respect to FIG. 6. FIG. 7A depicts a top portion of a marketplace listing including a brand and part type 702, a product subtitle 704 and a product image 706. Additionally, the marketplace listing of FIG. 7A depicts inventory data that includes a quantity 710 and a price 712. FIG. 7A also depicts distributor-related data, which includes a product condition 708, a return policy 714, shipping details 716 and an item location 718.

FIG. 7B depicts another portion of the marketplace listing, which includes product details 720 and product fitment data 722. FIG. 7C depicts additional information contained in the marketplace listing, including a distributor logo 724, a product name and part number 726, a product image 728, a distributor name and payment options 730, distributor customer support information 732, and shipping details 734. FIG. 7D depicts product brand information 736, distributor information 738, and a return policy 740.

As discussed above with respect to FIG. 6, various types of data are received and applied to listing template 602 to generate marketplace listings. In a particular embodiments, different types of data are updated at different frequencies. For example, product catalog data is updated approximately once per month, product fitment data is updated approximately once every three months, distributor inventory data is updated on a daily basis, sales activity is updated approximately once per day, and shipping confirmations are updated approximately once per day.

Each time data is updated, active marketplace listings are analyzed to determine whether any listings need to be modified or deleted based on the updated data. For example, if a distributor's inventory for a particular product has been depleted, any of the distributor's active marketplace listings for that depleted product should be deleted. Alternatively, the active marketplace listings for the depleted product can be suspended (e.g., temporarily deactivated) until the distributor's inventory is replenished.

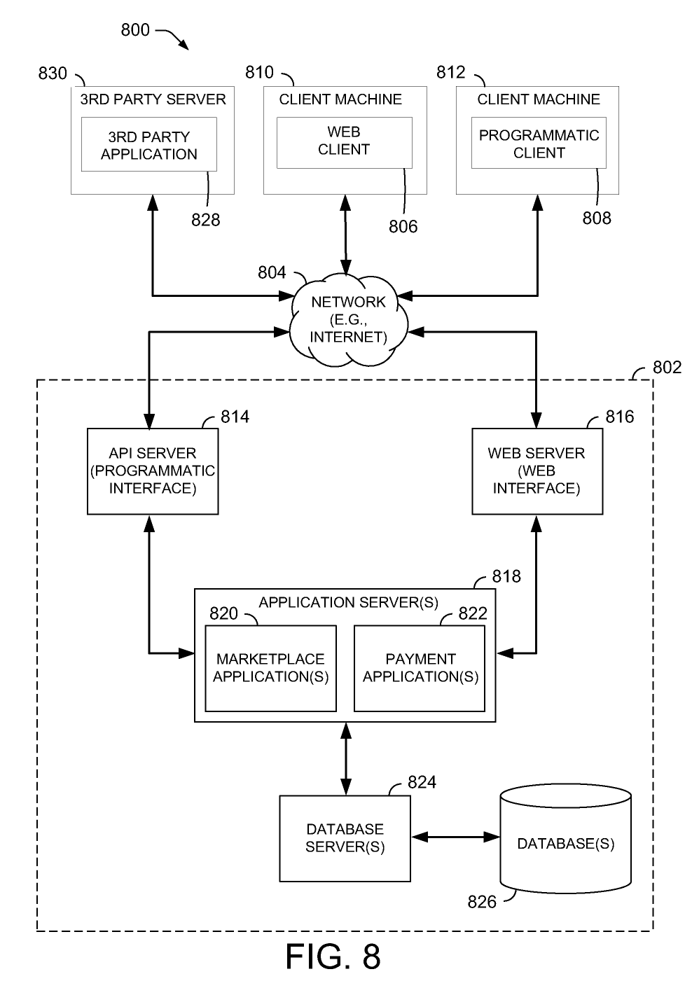

FIG. 8 is a network diagram depicting a client-server system 800, within which one example embodiment may be deployed. A networked system 802, in the example form of a network-based marketplace or publication system, provides server-side functionality, via a network 804 (e.g., the Internet or Wide Area Network (WAN)) to one or more clients. FIG. 8 illustrates, for example, a web client 806 (e.g., a browser, such as the Internet Explorer browser developed by Microsoft Corporation of Redmond, Wash.), and a programmatic client 808 executing on respective client machines 810 and 812.

An Application Programming Interface (API) server 814 and a web server 816 are coupled to, and provide programmatic and web interfaces respectively to, one or more application servers 818. Application servers 818 host one or more marketplace applications 820 and payment applications 822. Application servers 818 are, in turn, shown to be coupled to one or more database servers 824 that facilitate access to one or more databases 826.

Marketplace applications 820 may provide a number of marketplace functions and services to users that access networked system 802. Payment applications 822 may likewise provide a number of payment services and functions to users. Payment applications 822 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 820. While the marketplace and payment applications 820 and 822 are shown in FIG. 8 to both form part of networked system 802, it will be appreciated that, in alternative embodiments, payment applications 822 may form part of a payment service that is separate and distinct from networked system 802.

Further, while the system 800 shown in FIG. 8 employs a client-server architecture, the present invention is of course not limited to such an architecture, and could equally well find application in a distributed, or peer-to-peer, architecture system, for example. The various marketplace and payment applications 820 and 822 could also be implemented as standalone software programs, which do not necessarily have networking capabilities.

Web client 806 accesses the various marketplace and payment applications 820 and 822 via the web interface supported by web server 816. Similarly, programmatic client 808 accesses the various services and functions provided by the marketplace and payment applications 820 and 822 via the programmatic interface provided by API server 814. Programmatic client 808 may, for example, be a seller application (e.g., the TurboLister application developed by eBay Inc., of San Jose, Calif.) to enable sellers to author and manage listings on networked system 802 in an off-line manner, and to perform batch-mode communications between programmatic client 808 and networked system 802. Some embodiments of the present invention may be implemented by components of the marketplace application(s) 820.

FIG. 8 also illustrates a third party application 828, executing on a third party server machine 830, as having programmatic access to networked system 802 via the programmatic interface provided by API server 814. For example, third party application 828 may, utilizing information retrieved from networked system 802, support one or more features or functions on a website hosted by the third party. The third party website may, for example, provide one or more promotional, marketplace or payment functions that are supported by the relevant applications of the networked system 802.

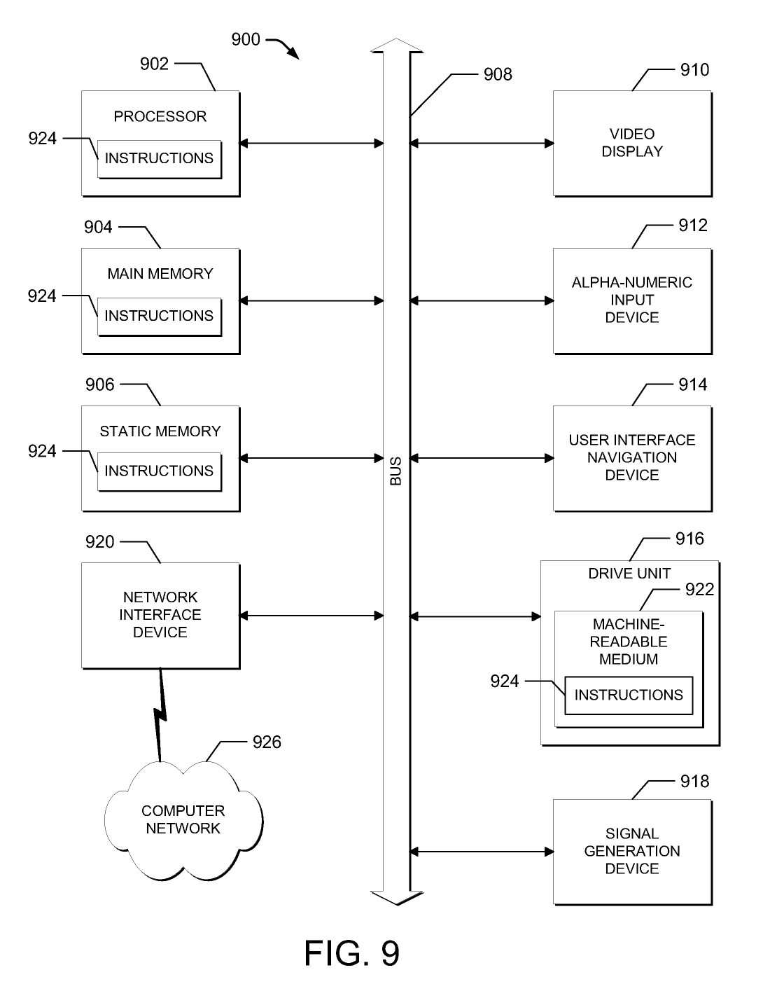

FIG. 9 shows a diagrammatic representation of machine in the example form of a computer system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU) a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a cursor control device 914 (e.g., a mouse), a disk drive unit 916, a signal generation device 918 (e.g., a speaker) and a network interface device 920.

The disk drive unit 916 includes a machine-readable storage medium 922 on which is stored one or more sets of instructions (e.g., software) 924 embodying any one or more of the methodologies or functions described herein. The software 924 may also reside, completely or at least partially, within the main memory 904, within the static memory 906, and/or within the processor 902 during execution thereof by the computer system 900, the main memory 904 and the processor 902 also constituting machine-readable media. The software 924 may further be transmitted or received over a network 926 via the network interface device 920.

While the machine-readable storage medium 922 is shown in an example embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing, encoding or carrying a set of instructions for execution by the machine and that cause the machine to perform any one or more of the methodologies of the present invention. The term “machine-readable storage medium” shall accordingly be taken to include, but not be limited to, solid-state memories, optical and magnetic media, and carrier wave signals.

Thus, a method and system for generating marketplace listings have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In the foregoing description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the description, with each claim standing on its own as a separate embodiment.

What is claimed is:

1. A method comprising:
receiving product information from a catalog service;
receiving a product listing request from the catalog service that identifies a product contained in the product information, the product listing request initiated by a distributor associated with the catalog service;
accessing distributor data associated with the distributor initiating the product listing request;
accessing a listing template associated with the product information; and
generating, using one or more processors, a marketplace listing based on the product, the distributor data, and the listing template.

2. The method of claim 1, further comprising receiving product inventory data associated with the distributor from the catalog service.

3. The method of claim 2, wherein the product inventory data includes an available quantity and a price associated with the product.

4. The method of claim 1, further comprising receiving product fitment data from the catalog service.

5. The method of claim 4, wherein the product fitment data identifies a plurality of devices with which the product is operable.

6. The method of claim 1, further comprising communicating the marketplace listing to a network-based marketplace.

7. The method of claim 6, wherein the distributor is registered with the network-based marketplace.

8. The method of claim 1, further comprising:
receiving additional product information from a second catalog service;
receiving a second product listing request from the second catalog service, the second product listing request initiated by a second distributor associated with the second catalog service; and
accessing distributor data associated with the second distributor.

9. The method of claim 8, further comprising generating a second marketplace listing based on the additional product information, the distributor data associated with the second distributor, and the listing template.

10. The method of claim 1, wherein the product information includes at least one of a product identifier, a brand, a part type, a part number, a category identifier, a product specification, a brand description, a product image, and a product subtitle.

11. The method of claim 1, wherein the distributor data includes at least one of a product return policy, a warranty, a distributor logo, and an item location.

12. The method of claim 1, further comprising:
receiving a second product listing request from the catalog service that identifies a second product in the product information, the second product listing request initiated by a second distributor associated with the catalog service; and
generating, using one or more processors, a second marketplace listing based on the second product, distributor data associated with the second distributor, and the listing template.

13. The method of claim 1, wherein the catalog service provides product information associated with a plurality of products manufactured by a plurality of entities.

14. The method of claim 1, wherein a plurality of distributors are associated with the catalog service, and each of the plurality of distributors access the same product information provided by the catalog service.

15. A system comprising:
an interface module configured to access product information from a plurality of catalog services coupled to the system; and
a marketplace listing manager configured to access distributor data from a network-based marketplace and access a listing template in response to a request to generate a marketplace listing for a product, the marketplace listing manager further configured to generate a marketplace listing for the product based on the product information, the distributor data, and the listing template.

16. The system of claim 15, wherein the marketplace listing manager is further configured to access distributor inventory data from one of the plurality of catalog services.

17. The system of claim 15, wherein the marketplace listing manager is further configured to communicate the marketplace listing for the product to the network-based marketplace.

18. A non-transitory machine-readable storage medium comprising instructions that, when executed by one or more processors of a machine, cause the machine to perform operations comprising:
receiving first product information from a first catalog service;
receiving second product information from a second catalog service;
accessing a listing template associated with the first product information and the second product information;
generating a first marketplace listing responsive to a request from a first distributor associated with the first catalog service, the first marketplace listing generated based on the first product information and the listing template;
generating a second marketplace listing responsive to a request from a second distributor associated with the second catalog service, the second marketplace listing generated based on the second product information and the listing template; and
communicating the first marketplace listing and the second marketplace listing to a network-based marketplace.

19. The non-transitory machine-readable storage medium of claim 18, wherein the first marketplace listing is further generated based on distributor data accessed from the network-based marketplace.

20. The non-transitory machine-readable storage medium of claim 18, wherein the first marketplace listing is further generated based on product fitment data received from the first catalog service.
